(19) United States
(12) Patent Application Publication
(10) Pub. No.: US 2014/0307033 A1
(43) Pub. Date: Oct. 16, 2014

(54) PRE-HEATING LIQUID EJECTED FROM A LIQUID DISPENSER

(71) Applicants: Yonglin Xie, Pittsford, NY (US); Qing Yang, Pittsford, NY (US)

(72) Inventors: Yonglin Xie, Pittsford, NY (US); Qing Yang, Pittsford, NY (US)

(21) Appl. No.: 13/859,817

(22) Filed: Apr. 10, 2013

(51) Int. Cl. B41J 2/04; B41J 2/05

(52) U.S. Cl. CPC B05B 9/002; B05B 9/035
USPC 347/54; 347/65

(57) ABSTRACT

A liquid dispenser array structure includes a substrate including a plurality of liquid dispensers. The plurality of liquid dispensers includes a liquid supply channel, a liquid dispensing channel including an outlet opening, and a liquid return channel including a vent located downstream relative to the location of the outlet opening of the liquid dispensing channel. A selectively actuatable first heater heats a portion of the liquid flowing through the liquid supply channel. A selectively actuatable second heater diverts the portion of the liquid previously heated by the first heater toward the outlet opening of the liquid dispensing channel. A liquid supply provides liquid under pressure to the plurality of liquid dispensers.

### FIELD OF THE INVENTION

This invention relates generally to the field of fluid dispensers and, in particular, to flow through liquid drop dispensers that eject on demand a quantity of liquid from a continuous flow of liquid.

### BACKGROUND OF THE INVENTION

Traditionally, inkjet printing is accomplished by one of two technologies referred to as “drop-on-demand” and “continuous” inkjet printing. In both, liquid, such as ink, is fed through channels formed in a print head. Each channel includes a nozzle from which droplets are selectively extruded and deposited upon a recording surface.

Drop-on-demand printing only provides drops (often referred to a “print drops”) for impact upon a print media. Selective activation of an actuator causes the formation and ejection of a drop that strikes the print media. The formation of printed images is achieved by controlling the individual formation of drops. Typically, one of two types of actuators is used in drop-on demand printing heat actuators and piezoelectric actuators. With heat actuators, a heater, placed at a convenient location adjacent to the nozzle, heats the ink. This causes a quantity of ink to phase change into a gaseous steam bubble that raises the internal ink pressure sufficiently for an ink droplet to be expelled. With piezoelectric actuators, an electric field is applied to a piezoelectric material possessing properties causing a wall of a liquid chamber adjacent to a nozzle to be displaced, thereby producing a pumping action that causes an ink droplet to be expelled.

Continuous inkjet printing uses a pressurized liquid source that produces a stream of drops some of which are selected to contact a print media (often referred to as “print drops”) while other are selected to be collected and either recycled or discarded (often referred to as “non-print drops”). For example, when no print is desired, the drops are deflected into a capturing mechanism commonly referred to as a catcher, interceptor, or gutter) and either recycled or discarded. When printing is desired, the drops are not deflected and allowed to strike a print media. Alternatively, deflected drops can be allowed to strike the print media, while non-deflected drops are collected in the capturing mechanism.

Printing systems that combine aspects of drop-on-demand printing and continuous printing are also known. These systems, often referred to as flow through, continuous on demand, or captive continuous liquid dispensers, provide increased drop ejection frequency when compared to drop-on-demand printing systems without the complexity of continuous printing systems. As such, there is an ongoing need and effort to increase the reliability and performance of flow through liquid drop dispensers.

### SUMMARY OF THE INVENTION

According to an aspect of the invention, a liquid dispenser array structure includes a substrate including a plurality of liquid dispensers. The plurality of liquid dispensers includes a liquid supply channel, a liquid dispensing channel including an outlet opening, and a liquid return channel including a vent located downstream relative to the location of the outlet opening of the liquid dispensing channel. A selectively actuatable first heater heats a portion of the liquid flowing through the liquid supply channel. A selectively actuatable second heater diverts the portion of the liquid previously heated by the first heater toward the outlet opening of the liquid dispensing channel. A liquid supply provides liquid under pressure to the plurality of liquid dispensers.

In one example embodiment of the invention, a controller is configured to provide a pulsed waveform to the selectively actuatable first heater and a pulsed waveform to the selectively actuatable second heater. In operation, the pulsed waveform provided to the selectively actuatable first heater and the pulsed waveform provided to the selectively actuatable second heater are coordinated to cause the selectively actuatable first and second heaters to act upon the same liquid portion. In another example embodiment of the invention, a controller is configured to provide a constant activation current to the selectively actuatable first heater.

The characteristics of the first heater and second heater can be different when compared to each other in example embodiments of the invention. For example, heater size, heater shape, heater passivation layer(s) types, thermal barrier layer(s) types, or material layer(s) thickness can be different when comparing the first heater and second heaters to each other. In one example embodiment of the invention, the first heater includes a plurality of selectively actuatable heater element segments which incrementally heat the liquid portion flowing through the liquid dispenser.

According to an aspect of the invention, a method of ejecting liquid from a liquid dispenser of a liquid dispenser array structure includes providing a plurality of liquid dispensers on a substrate. The plurality of liquid dispensers includes a liquid supply channel, a liquid dispensing channel including an outlet opening, and a liquid return channel including a vent located downstream relative to the location of the outlet opening of the liquid dispensing channel. A selectively actuatable first heater heats a portion of the liquid flowing through the liquid supply channel. A selectively actuatable second heater diverts the portion of the liquid previously heated by the first heater toward the outlet opening of the liquid dispensing channel. A liquid supply provides liquid under pressure to the plurality of liquid dispensers. During liquid ejection, pressurized liquid is continuously provided to the plurality of liquid dispensers by the liquid supply. A portion of the liquid flowing through the liquid supply channel is heated by selectively actuating the first heater. The portion of the liquid previously heated by the first heater is diverted toward the outlet opening of the liquid dispensing channel by selectively actuating the second heater.

### BRIEF DESCRIPTION OF THE DRAWINGS

In the detailed description of the example embodiments of the invention presented below, reference is made to the accompanying drawings, in which:

FIG. 1A and FIG. 1B are schematic cross sectional and plan views, respectively, of an example embodiment of a conventional liquid dispenser;

FIG. 1C is a schematic diagram of a liquid supply system that provides liquid to the liquid dispenser shown in FIGS. 1A and 1B;

FIG. 2A and FIG. 2B are schematic cross sectional and plan views, respectively, of an example embodiment of a liquid dispenser made in accordance with the present invention;

FIG. 3A and FIG. 3B are schematic cross sectional and plan views, respectively, of another example embodiment of a liquid dispenser made in accordance with the present invention;

FIG. 4A is a schematic cross sectional view of the example embodiment of the liquid dispenser shown in FIGS. 2A and 2B;

FIG. 4B shows an example embodiment of a pulsed waveform provided by a controller to one of the thermal actuators shown in FIG. 4A;

FIG. 4C shows an example embodiment of a pulsed waveform provided by a controller to the other thermal actuator shown in FIG. 4A; and

FIG. 5A and FIG. 5B are schematic cross sectional and plan views, respectively, of another example embodiment of a liquid dispenser made in accordance with the present invention.

### DETAILED DESCRIPTION OF THE INVENTION

The invention has been described in detail with particular reference to certain preferred embodiments thereof, but it will be understood that variations and modifications can be effected within the spirit and scope of the invention. It is to be understood that elements not specifically shown or described may take various forms well known to those skilled in the art. In the following description and drawings, identical reference numerals have been used, where possible, to designate identical elements.

The example embodiments of the present invention are illustrated schematically and not to scale for the sake of clarity. One of the ordinary skills in the art will be able to readily determine the specific size and interconnections of the elements of the example embodiments of the present invention.

As described herein, the example embodiments of the present invention provide a liquid dispenser, often referred to as a printhead, which is particularly useful in digitally controlled inkjet printing devices in which drops of ink are ejected from a printhead toward a print medium. However, many other applications are emerging which use liquid dispensers, similar to inkjet printheads, to emit liquids, other than inks, that need to be finely metered and deposited with high spatial precision. As such, as described herein, the terms “liquid” and “ink” are used interchangeably and refer to any material, not just inkjet inks, which can be ejected by the example embodiments of the liquid dispenser described below.

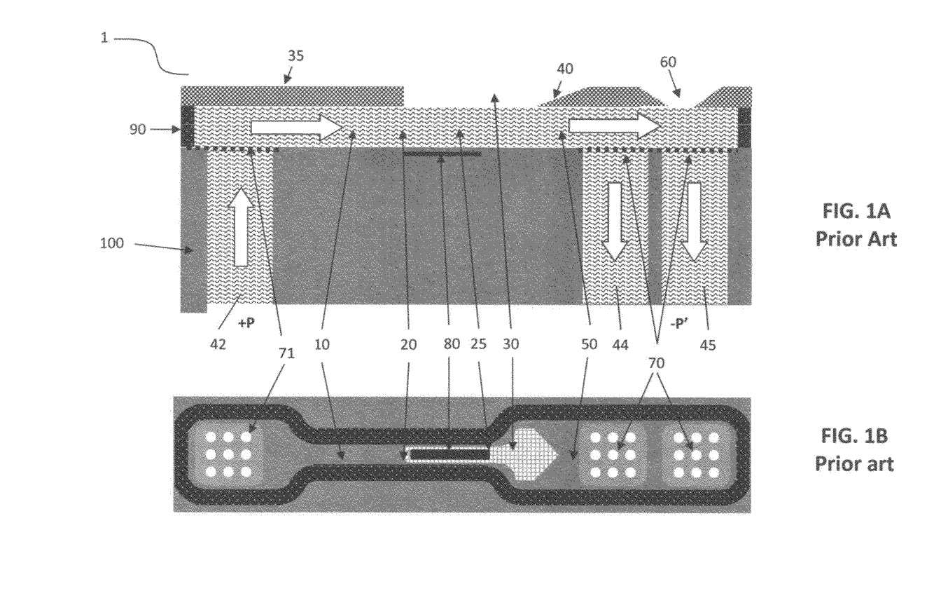

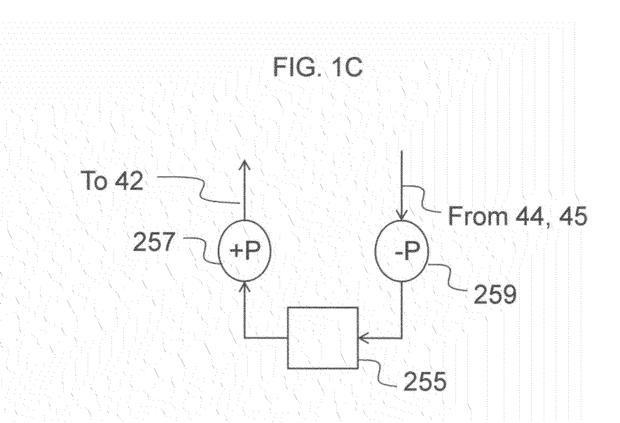

Referring to FIGS. 1A and 1B, an example embodiment of a liquid dispenser is shown. Liquid dispenser 1 is conventional having been described in US Patent Application Publication NO. 2012/0098902 A1, published by Xie et al., on Apr. 26, 2012, the disclosure of which is incorporated by reference in its entirety herein. Liquid dispenser 1 includes a liquid supply channel 10 that is in fluid communication with a liquid return channel 50 through a liquid dispensing channel 25. Liquid dispensing channel 25 includes a liquid diverter member 80. Diverter member 80 determines the size (for example, volume) of a drop ejected through an outlet opening 30. Typically, the size of drops created is proportional to the amount of liquid displaced by the actuation of diverter member 80. Liquid supply channel 10 includes an exit 20 while liquid return channel 50 includes an entrance. The downstream edge 40 of outlet opening 30 at least partially defines the entrance of liquid return channel 50.

Diverter member 80, associated with liquid dispensing channel 25, is selectively actuated to divert a portion of the liquid traveling through liquid dispensing channel 25 toward and through outlet opening 30 of liquid dispensing channel 25 in order to form and eject a drop (not shown). The flow path of the liquid is indicated using the arrows included in FIG. 1A. Diverter member 80 can include a heater or can incorporate using heat in its actuation. As shown in FIG. 1, diverter member 80 includes a heater that vaporizes a portion of the liquid flowing through liquid dispensing channel 25 so that another portion of the liquid is diverted toward downstream edge of the outlet opening 40. This type of heater is commonly referred to as a “bubble jet” heater. As shown in FIGS. 1A and 1B, the liquid moves over heater 80.

As shown in FIGS. 1A and 1B, liquid supply channel 10, liquid dispensing channel 25, and liquid return channel 50 are partially defined by portions of substrate 100. These portions of substrate 100 can also be referred to as a wall or walls of one or more of liquid supply channel 10, liquid dispensing channel 25, and liquid return channel 50. A wall 35 defines outlet opening 30 and also partially defines liquid supply channel 10, liquid dispensing channel 25, and liquid return channel 50. Portions of substrate 100 also define a liquid supply passage 42 and liquid return passages 44, 45. Again, these portions of substrate 100 can be referred to as a wall or walls of liquid supply passage 42 and liquid return passages 44, 45. Liquid supply passage 42 and liquid return passages 44,45 are perpendicular to liquid supply channel 10, liquid dispensing channel 25, and liquid return channel 50.

Referring to FIG. 1C, a liquid supply and recirculation system is connected in fluid communication to liquid dispenser 1. The liquid supply and recirculation system provides liquid to liquid dispenser 1 at a pressure +P that is above atmospheric pressure at the liquid supply passage 42. The liquid supply and recirculation system recovers liquid from the liquid dispenser 1 by supplying a negative pressure −P at the outlet of liquid return passages 44, 45. A regulated vacuum supply source, for example, a pump, can be included in the liquid return system of the liquid supply and recirculation system in order to better control liquid flow through liquid dispenser and provide a vacuum (negative) pressure that is below atmospheric pressure.

As shown in FIG. 1 C, liquid supply passage 42 and liquid return passages 44, 45 are also in fluid communication with a liquid supply 255. During a drop ejection or dispensing operation, liquid supply 255 provides a pressurized liquid that flows continuously from liquid supply 255 through liquid supply passage 42, through liquid supply channel 10, through liquid dispensing channel 25, through liquid return channel 50, through liquid return passages 44, 45, and back to liquid supply 255. Liquid circulation helps to increase the drop ejection frequency by removing at least some of the heat generated by heater 80 when it is actuated during drop ejection. Liquid circulation can also help increase the drop ejection frequency by pushing at least some of the vapor bubble formed when heater 80 is actuated off of and away from heater 80 area as the vapor bubble collapses.

Typically, a regulated pressure source 257 is positioned in fluid communication between liquid supply 255 and liquid supply passage 42. Regulated pressure source 257, for example, a pump, provides a positive pressure that is usually above atmospheric pressure. Optionally, a regulated vacuum supply 259, for example, a pump, can be included in order to better control liquid flow through second chamber 212. Typically, regulated vacuum supply 259 is positioned in fluid communication between liquid return passages 44, 45 and liquid supply 255 and provides a vacuum (negative) pressure that is below atmospheric pressure. Liquid supply 255, regulated pressure source 257, and optional regulated vacuum supply 259 can be referred to as the liquid delivery system of liquid dispenser 1.

Liquid supply channel 10 or liquid supply passage 42 can optionally include a porous member 71, for example, a filter, which provides particulate filtering of the liquid flowing through liquid dispenser 1. Liquid return channel 50 or liquid supply return passages 44, 45 can optionally include a porous member 70, for example, a filter, which, in addition to providing particulate filtering of the liquid flowing through liquid dispenser, helps to accommodate liquid flow and pressure changes in liquid supply return channel 50 associated with actuation of diverter member 80 and a portion of liquid in the liquid dispensing channel 25 being deflected toward and through outlet opening 30. This reduces the likelihood of liquid spilling over outlet opening 30 of liquid dispensing channel 25 during actuation of diverter member 80. The likelihood of air being drawn into liquid return passages 44, 45 is also reduced when porous member 70 is included in liquid dispenser 1.

Liquid return channel 50 includes a vent 60 that opens liquid return channel 50 to atmosphere. Vent 60 helps to accommodate liquid flow and pressure changes in liquid return channel 50 associated with actuation of diverter member 80 and a portion of liquid in the liquid dispensing channel 25 being deflected toward and through outlet opening 30. This reduces the likelihood of liquid spilling over outlet opening 30 of liquid dispensing channel 25 during actuation of diverter member 80. In the event that liquid does spill over outlet opening 30, vent 60 also acts as a drain that provides a path back to liquid return channel 50 for any overflowing liquid. As such, the terms “vent” and “drain” are used interchangeably herein.

As shown in FIG. 1, there is a plurality of liquid return passages 44, 45. The overall (aggregate) size of liquid return passage 44, 45 is greater than the size of liquid supply passage 42 but the size and shape of individual liquid return passages 44 and 45 is approximately equal to the size and shape of liquid supply passage 42. It is believed that this feature not only accommodates liquid flow and pressure changes in liquid return channel 50 which reduces the likelihood of liquid spilling over outlet opening 30 of liquid dispensing channel 25, but also facilitates the manufacturing of liquid dispenser 1 and improves the heat dissipation from diverter member 80 to the liquid flowing through individual liquid return passages 44 and 45.

Liquid dispenser 1 is typically formed from a semiconductor material (for example, silicon) using known semiconductor fabrication techniques (for example, CMOS circuit fabrication techniques, microelectromechanical system (MEMS) fabrication techniques, or combination of both). Alternatively, liquid dispenser 1 can be formed from any materials using any fabrication techniques known in the art. The liquid dispensers of the present invention, like conventional drop-on-demand inkjet printheads, only create drops when desired, eliminating the need for a gutter and the need for a drop deflection mechanism which directs some of the created drops to the gutter while directing other drops to print receiving media. The liquid dispensers of the present invention, like conventional continuous inkjet printheads, use a liquid supply that supplies liquid, for example, ink under pressure to the printhead. The supplied ink pressure serves as the primary motive force for the ejected drops, so that most of the drop momentum is provided by the pressurized liquid from the liquid supply rather than by a drop ejection actuator located, for example, at the nozzle.

Liquid ejected by liquid dispenser 1 of the present invention does not need to travel through a conventional nozzle which typically has a smaller area than outlet opening 30. This helps to reduce the likelihood of outlet opening 30 becoming contaminated or clogged by particle contaminants. Using a larger outlet opening 30 (as compared to a conventional nozzle) also reduces latency problems at least partially caused by evaporation in the nozzle during periods when drops are not being ejected. The larger outlet opening 30 also reduces the likelihood of satellite drop formation during drop ejection because drops are produced with shorter tail lengths.

The liquid dispenser array structure of the present invention includes a plurality of liquid dispensers 1, also referred to as liquid dispensing elements, on a common substrate 100. In this sense, substrate 100 typically includes a plurality of liquid dispensers 1. The liquid dispensers are typically arranged in an array on substrate 100. The liquid dispensers can be integrally formed on the common substrate using the fabrication techniques described above thereby creating a monolithic liquid dispenser array structure. When compared to other types of liquid dispensers, monolithic dispenser configurations help to improve the alignment of each outlet opening relative to other outlet openings which improves image quality. Monolithic dispenser configurations also help to reduce spacing in between adjacent outlet openings which increases dots per inch (dpi).

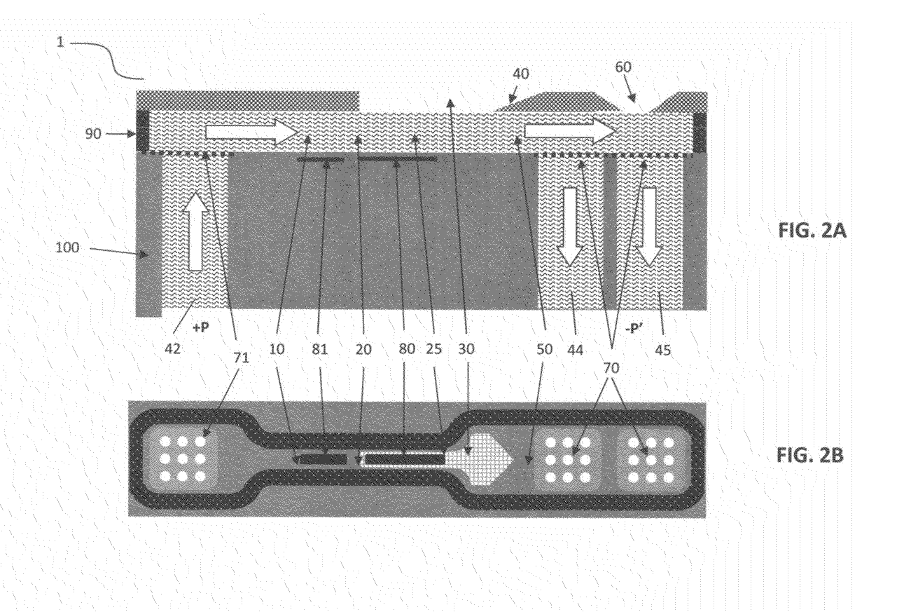

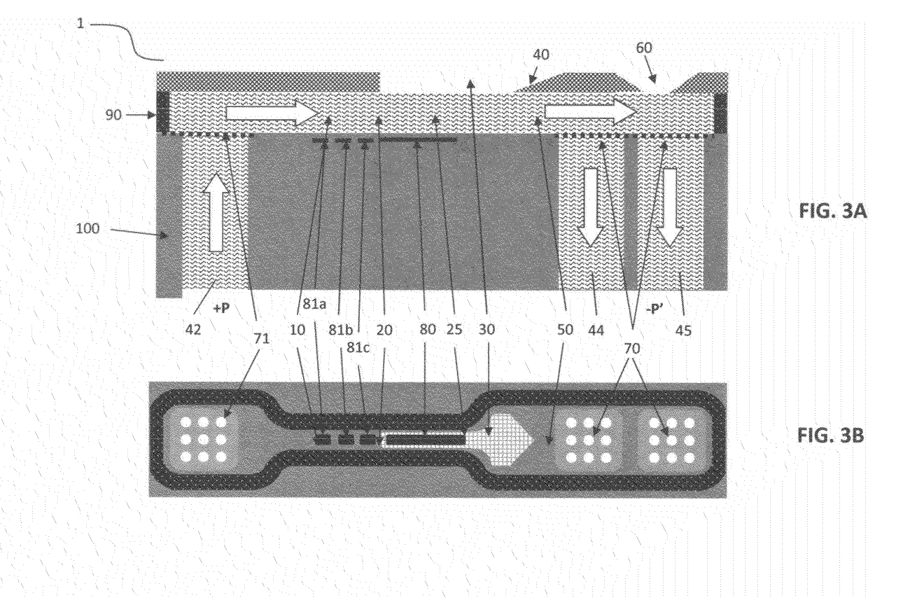

Referring to FIGS. 2A-3B, example embodiments of a liquid dispenser made with the present invention is shown. Liquid dispenser 1 includes a liquid supply channel 10 that is in fluid communication with a liquid return channel 50 through a liquid dispensing channel 25 including an outlet opening 30 as well as the other elements described above. In FIGS. 2A-3B, liquid supply channel 10 includes a selectively actuated first heater 81 that heats a portion of the liquid flowing through the liquid supply channel 10. Liquid dispensing channel 25 includes a selectively actuated second heater 80 that diverts the portion of the liquid previously heated by the first heater 81 toward the outlet opening of the liquid dispensing channel. The characteristics of the selectively actuated first heater 81 of liquid dispenser 1 are different when compared to the characteristics of the selectively actuated second heater 80 because each heater performs a different function. The different characteristics of the selectively actuated first heater and the selectively actuated second heater are, typically, one of heater area, heater aspect ratio, or heater resistance.

As shown in FIGS. 2A and 2B, first heater 81 is a single heater that is positioned in liquid supply channel 10. In FIGS. 3A and 3B, selectively actuated first heater 81 of liquid dispenser 1 includes a plurality of heater segments 81a, 81b, 81c (as shown in this example embodiment) that incrementally heat the portion of the liquid flowing through the liquid supply channel 10. Each segment of the plurality of heater segments of heater 81 is individually addressable and can be activated in sequence to incrementally heat the same portion of the liquid flowing through the liquid supply channel 10. The number of heater segments activated can be changed by a controller to provide wide range of heating to the portion of the liquid flowing through the liquid supply channel 10.

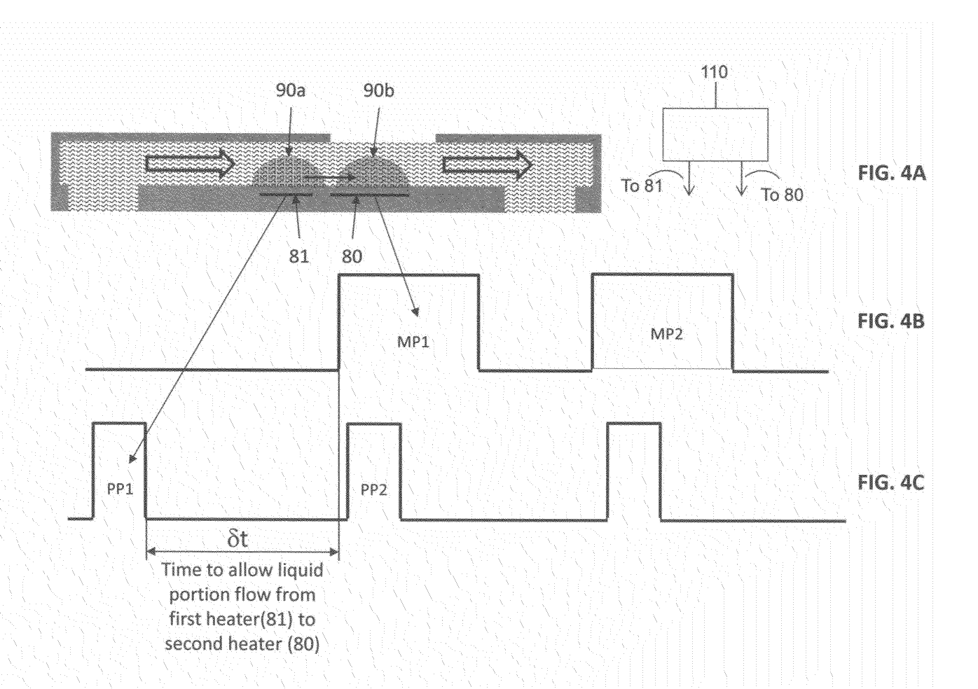

Referring to FIGS. 4A-4C, a controller 110 is configured to provide a first pulsed waveform to selectively actuated first heater 81 that heats a portion of the liquid 90a flowing through the liquid supply channel 10. Sometime after the first pulsed waveform is turned off, the portion of the liquid 90a previously heated by the selectively actuated first heater 81 flows downstream to a new location 90b over selectively actuated second heater 80 in the liquid dispensing channel 25. Controller 110 is configured to provide a second pulsed waveform to selectively actuated second heater 80 that heats liquid portion 90b previously heated by first heater 81(and referred to as liquid portion 90a) and now flowing through liquid dispensing channel 25. An example embodiment of the first pulsed waveform provided by controller 110 to the selectively actuated first heater 81 is shown in FIG. 4C. An example embodiment of the second pulsed waveform provided by controller 110 to the selectively actuated second heater 80 is shown in FIG. 4B.

The first pulsed waveform provided to first heater 81 and the second pulsed waveform provided to second heater 80 are coordinated to cause the selectively actuatable first and second heaters to act upon the same liquid portion 90a, 90b as the liquid portion moves in the direction indicated by the arrows included in FIG. 4A. The energy level of the first pulsed waveform provided to the selectively actuatable first heater 81 is used to control the temperature of the liquid portion 90b over the second heater 80 immediately before the start of the second pulsed waveform provided by the controller to the second heater 80.

Second heater 80 determines the size (for example, volume) of the ejected drop. Typically, the size of drops created is proportional to the amount of liquid displaced by the actuation of the second heater 80. The amount of liquid displaced by the actuation of the second heater 80 depends on the size of the second heater 80, the energy level of the second pulsed waveform to second heater 80, and the temperature of the liquid portion 90b over the second heater 80 immediately before the start of the second pulsed waveform provided by the controller to the second heater 80.

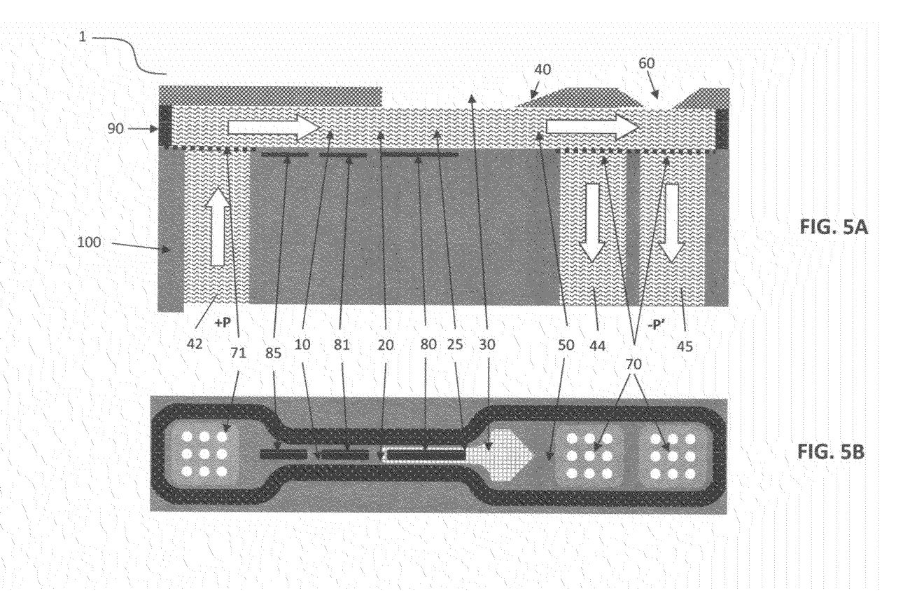

Referring to FIG. 5, another example embodiment of a liquid dispenser 1 made with the present invention is shown. Liquid dispenser 1 includes a temperature sensing element, sensor 85, in the liquid supply channel 10 that is in thermal communication with a liquid in the liquid supply channel 10 that senses the temperature of the liquid moving through liquid dispenser 1. The temperature of the liquid dispenser 1 changes during printing depending on the coverage of the printed document as well as the time of continuous printing. For example, for the same time of continuous printing, the higher the coverage of the printed document, the higher the liquid dispenser 1 temperature. Also, for the same coverage of the printed document, the longer the time of continuous printing, the higher the liquid dispenser 1 temperature.

As the temperature of the liquid dispenser 1 increases, the temperature of the liquid portion over the selectively actuatable first heater 80 rises. The drop volume or drop velocity of the drops produced by liquid dispenser 1 will increase if the energy level of first pulsed waveform provided by controller 110 to the selectively actuatable first heater 81 and the energy level of second pulsed waveform provided by controller 110 to the selectively actuatable second heater 80 is unchanged. To keep the drop volume and drop velocity produced by the liquid dispenser 1 constant during printing, the energy level of first pulsed waveform provided by controller 110 to first heater 81 is adjusted during operation depending on the temperature measured by the temperature sensing element 85. At a relatively low temperature, the energy level of first pulsed waveform provided by controller 110 to first heater 81 is correspondingly relatively high. As the temperature of liquid dispenser 1 rises during operation, the energy level of first pulsed waveform provided by controller 110 to first heater 81 is decreased to help maintain a constant drop volume and drop velocity.

In another embodiment of the present invention, controller 110 of liquid dispenser 1 is configured to provide a constant activation current to the selectively actuatable first heater 81. The complexity of controller 110 so configured is less than that of a controller configured to provide the pulsed waveform described above. This example embodiment also can include a temperature sensing element 85 to measure the temperature of the liquid dispenser 1. As described above, the temperature of the liquid dispenser 1 depends on the coverage of the printed document as well as the time of continuous printing. For the same time of continuous printing, the higher the coverage of the printed document, the higher the liquid dispenser 1 temperature. For the same coverage of the printed document, the longer time of continuous printing, the higher the temperature of liquid dispenser 1. During operation, the level of activation current provided by controller 110 is adjusted depending on the temperature measured by the temperature sensing element. At low temperature, the level of activation current is high. As the temperature of the liquid dispenser rises during operation, the level of activation current provided by the controller to the selectively actuatable first heater 81 decreases to help maintain a constant drop volume and drop velocity.

The example embodiments described above can be implemented individually (by themselves) or in combination with each other to obtain the desired performance of the liquid dispenser of the present invention. The invention has been described in detail with particular reference to certain preferred embodiments thereof, but it will be understood that variations and modifications can be effected within the scope of the invention.

### PARTS LIST

1 liquid dispenser

10 liquid supply channel

20 liquid supply channel exit

25 liquid dispensing channel

30 outlet opening

35 wall

40 downstream edge of outlet opening

42 liquid supply passage

44 liquid return passage

45 liquid return passage

50 liquid return channel

60 vent or drain

71 porous member

70 porous member

80 diverter member; second heater

81 first heater

81a-c first heater segments

85 temperature sensing element

90b liquid portion over the second heater

90a liquid portion over the first heater

100 substrate

110 controller

255 liquid supply

257 pressure source

259 vacuum supply

1. A liquid dispenser array structure comprising:
a substrate including a plurality of liquid dispensers, the plurality of liquid dispensers including:
a liquid supply channel;
a liquid dispensing channel including an outlet opening;
a liquid return channel including a vent located downstream relative to the location of the outlet opening of the liquid dispensing channel; and
a selectively actuatable first heater that heats a portion of the liquid flowing through the liquid supply channel;
a selectively actuatable second heater that diverts the portion of the liquid previously heated by the first heater toward the outlet opening of the liquid dispensing channel; and
a liquid supply that provides liquid under pressure to the plurality of liquid dispensers.

2. The liquid dispenser array of claim 1, wherein at least a portion of the first heater is positioned in the liquid dispensing channel.

3. The liquid dispenser array of claim 1, further comprising:
a controller configured to provide a pulsed waveform to the selectively actuatable first heater.

4. The liquid dispenser array of claim 3, the controller configured to provide a pulsed waveform to the selectively actuatable second heater, wherein the pulsed waveform provided to the selectively actuatable first heater and the pulsed waveform provided to the selectively actuatable second heater are coordinated to cause the selectively actuatable first and second heaters to act upon the same liquid portion.

5. The liquid dispenser array of claim 3, further comprising:
a temperature sensor that provides a signal related to a temperature of the liquid provided to at least one of the liquid dispensers.

6. The liquid dispenser of claim 6, wherein the controller is configured to adjust the pulsed waveform provided to the selectively actuatable first heater in response to the signal provided by temperature sensor to adjust the temperature of the liquid that is acted on by the second heater.

7. The liquid dispenser array of claim 1, further comprising:
a controller configured to provide a constant activation current to the selectively actuatable first heater.

8. The liquid dispenser array of claim 7, further comprising:
a temperature sensor that provides a signal related to a temperature of the liquid provided to at least one of the liquid dispensers.

9. The liquid dispenser of claim 8, wherein the controller is configured to adjust the constant activation current provided to the selectively actuatable first heater in response to the signal provided by temperature sensor to adjust the temperature of the liquid that is acted on by the second heater.

10. The liquid dispenser array of claim 1, wherein the characteristics of the selectively actuatable first heater are different when compared to the characteristics of the selectively actuatable second heater.

11. The liquid dispenser of claim 1, wherein the selectively actuatable first heater includes a plurality of heater segments that incrementally heat the portion of the liquid flowing through the liquid supply channel.

12. A method of ejecting liquid from a liquid dispenser of a liquid dispenser array structure comprising:
providing a substrate including a plurality of liquid dispensers, the plurality of liquid dispensers including:
a liquid supply channel;
a liquid dispensing channel including an outlet opening;
a liquid return channel including a vent located downstream relative to the location of the outlet opening of the liquid dispensing channel; and
a selectively actuatable first heater that heats a portion of the liquid flowing through the liquid supply channel;
a selectively actuatable second heater that diverts the portion of the liquid previously heated by the first heater toward the outlet opening of the liquid dispensing channel;
providing a liquid supply that provides liquid under pressure to the plurality of liquid dispensers;
continuously providing pressurized liquid to the plurality of liquid dispensers using the liquid supply;
heating a portion of the liquid flowing through the liquid supply channel by selectively actuating the first heater; and
diverting the portion of the liquid previously heated by the first heater toward the outlet opening of the liquid dispensing channel by selectively actuating the second heater.
